(19) United States
(12) Patent Application Publication
(10) Pub. No.: US 2014/0347393 A1
(43) Pub. Date: Nov. 27, 2014

(54) SERVER APPARATUS AND COMMUNICATION METHOD

(71) Applicant: YAMAHA CORPORATION, Hamamatsu-shi (JP)

(72) Inventors: Hiroki INOUE, Hamamatsu-shi (JP); Akie HINOKIO, Hamamatsu-shi (JP); Ryoya KAWAI, Tokyo (JP); Kouhei SUMI, Hamamatsu-shi (JP)

(73) Assignee: YAMAHA CORPORATION, Hamamatsu-shi (JP)

(21) Appl. No.: 14/284,485

(22) Filed: May 22, 2014

(30) Foreign Application Priority Data
May 23, 2013 (JP) 2013-108807

(51) Int. Cl. G06T 19/00

(52) U.S. Cl. CPC G06T 19/006
USPC 345/633

(57) ABSTRACT

A server apparatus includes a processor, configured to acquire object specifying information for specifying an object in a reality space captured by a first portable terminal, to acquire condition information including an external condition of the first portable terminal, and to acquire content information associated with the object specifying information and the condition information by referring to a database. The database stores, in association with one another, content information representing a content displayed by being superimposed on an object in a reality space captured by a second portable terminal, object information for identifying the object captured by the second portable terminal, and condition information representing a condition for displaying, in the first portable terminal, the content represented by the content information. The processor of the server apparatus is also configured to transmit the content information to the first portable terminal.

### CROSS REFERENCE TO RELATED APPLICATIONS

The present application is based on and claims the benefit of Japanese patent application No. 2013-108807, filed on May 23, 2013, the contents of which are incorporated herein by reference in its entirety.

### BACKGROUND OF THE INVENTION

1. Field of the Invention

The present invention relates to an augmented reality (AR) technology.

2. Description of the Related Art

In recent years, various services using the AR technology have been provided. For example, Non-Patent Literature (Tonchidot Corporation, “Sekai Camera Support Center” [online], posted on Dec. 20, 2010, [searched on May 1, 2013], the Internet <URL: http://support.sekaicamera.com/ja/service>) discloses a service of associating digital information called an “air tag” with a position in a reality space, registering the position, and displaying, when a smartphone captures the reality space at the registered position, the air tag by superimposing the air tag in the captured reality space.

### SUMMARY OF THE INVENTION

According to the technology disclosed in the related art, a posted air tag is browsed a large indefinite number of users. Users who post the air tag cannot designate conditions such as a time in which the air tag should be displayed, a weather condition, and a reader attribute.

One non-limited object of the present invention is to enable, according to conditions such as a time, a weather condition, and a reader attribute, the display of a content to be displayed by superimposing an object in a reality space captured by a portable terminal.

An aspect of the present invention provides a server apparatus. The server apparatus includes a processor, configured to acquire object specifying information for specifying an object in a reality space captured by a first portable terminal, to acquire condition information including an external condition of the first portable terminal, and to acquire content information associated with the object specifying information and the condition information by referring to a database. The database stores, in association with one another, content information representing a content displayed by being superimposed on an object in a reality space captured by a second portable terminal, object information for identifying the object captured by the second portable terminal, and condition information representing a condition for displaying, in the first portable terminal, the content represented by the content information. The processor of the server apparatus is also configured to transmit the content information to the first portable terminal.

In accordance with the aspect of the present invention, a content displayed by being superimposed on an object in a reality space captured by a portable terminal can be displayed according to conditions such as a time, a weather condition, and a reader attribute.

### BRIEF DESCRIPTION OF THE DRAWINGS

In the accompanying drawings:

FIG. 1 is a schematic diagram illustrating a configuration of a communication system 1;

FIG. 2 is a block diagram illustrating a hardware configuration of a portable terminal 2;

FIG. 3 is a block diagram illustrating a configuration of functions implemented by a central processing unit (CPU) 21;

FIG. 4 is a block diagram illustrating a hardware configuration of a database (hereinafter referred to as DB) server 3;

FIG. 5 is a table illustrating an example of a data organization of a tag setting information DB 321;

FIG. 6 is a block diagram illustrating a configuration of a function implemented by a CPU 31;

FIG. 7 is a block diagram illustrating another configuration of a function implemented by the CPU 31;

FIG. 8 is a block diagram illustrating a hardware configuration of a file server 4;

FIG. 9 is a sequence chart illustrating tag setting information uploading processing;

FIG. 10 is a sequence chart illustrating tag information downloading processing;

FIG. 11 is an image view illustrating an example of a display-screen-image;

FIG. 12 is an image view illustrating an example of the display-screen-image; and

FIG. 13 is a sequence chart illustrating a sound file reproducing processing.

### DETAILED DESCRIPTION OF THE EXEMPLARY EMBODIMENTS

Some aspects of the present invention are described as follows.

An aspect of the present invention provides a server apparatus, including: a first object specifying information acquisition unit configured to acquire object specifying information for specifying an object in a reality space captured by a first portable terminal; a first condition information acquisition unit configured to acquire condition information including an external condition of the first portable terminal; a first content information acquisition unit configured to acquire content information associated with the object specifying information acquired by the first object specifying information acquisition unit and the condition information acquired by the first condition information acquisition unit by referring to a database, wherein the database stores content information representing a content displayed by being superimposed on an object in a reality space captured by a second portable terminal, object information for identifying the object captured by the second portable terminal, and condition information representing a condition for displaying, in the first portable terminal, the content represented by the content information by associating the content information, the object information, and the condition information with one another; and a transmission unit configured to transmit, to the first portable terminal, the content information acquired by the first content information acquisition unit.

The server apparatus may be configured so that the external condition of the first portable terminal includes a situation into which the first portable terminal is put.

The server apparatus may be configured so that the external condition of the first portable terminal includes attribute information on a user of the first portable terminal.

The server apparatus may be configured so that the first portable terminal is same as the second portable terminal.

The server apparatus may be configured so that the first portable terminal differs from the second portable terminal.

The server apparatus may be configured so that the content information includes identification information representing a sound file.

The server apparatus may be configured by further including: a second content information acquisition unit configured to acquire content information representing a content to be displayed by being superimposed on an object in a reality space captured by the second portable terminal; a second object specifying information acquisition unit configured to acquire object specifying information for specifying the object captured by the second portable terminal; a second condition information acquisition unit configured to acquire condition information representing a condition for displaying, in the first portable terminal, the content represented by the content information; and a storage controller configured to store the content information acquired by the second content information acquisition unit, the object specifying information acquired by the second object specifying information acquisition unit and the condition information acquired by the second condition information acquisition unit into the database by associating the content information, the object specifying information, and the condition information with one another.

An aspect of the present invention provides a server apparatus, including: a content information acquisition unit configured to acquire content information representing a content to be displayed by being superimposed on an object in a reality space captured by a portable terminal; an object specifying information configured to acquire object specifying information for specifying the object captured by the portable terminal; a condition information acquisition unit configured to acquire condition information that represents a condition for displaying a content represented by the content information in the portable terminal or another portable terminal and that includes an external condition of the portable terminal; and a storage controller configured to store the content information, the object specifying information and the condition information into a database by associating the content information, the object specifying information and the condition information with one another.

The server apparatus may be configured so that the external condition of the portable terminal includes a situation in which the portable terminal is put.

The server apparatus may be configured so that the external condition of the portable terminal includes attribute information on a user of the portable terminal.

The server apparatus may be configured so that the content information includes identification information representing a sound file.

An aspect of the present invention provides a a communication method performed in a communication system including a plurality of portable terminals and a server apparatus, the communication method including: causing a first portable terminal to transmit, to the server apparatus, object specifying information for specifying an object in a reality space captured by the first portable terminal; causing the server apparatus to receive the object specifying information transmitted to the server apparatus; causing the server apparatus to acquire condition information representing an external condition of the first portable terminal; and causing the server apparatus to acquire content information associated with the received object specifying information and the acquired condition information by referring to a database, wherein the database stores content information representing a content to be displayed by being superimposed on an object in a reality space captured by a second portable terminal, object information for identifying the object captured by the second portable terminal, and condition information representing a condition for displaying, in the first portable terminal, a content represented by the content information, by associating the content information, the object information, and the condition information with one another.

The communication method may be configured so that the first portable terminal transmits the condition information to the server apparatus, together with the object specifying information, and the server apparatus acquires the condition information from the first portable terminal.

The communication method may be configured by further including: causing the second portable terminal to transmit, to the server apparatus, the content information representing a content to be displayed by being superimposed on the object captured by the second portable terminal, the object specifying information for specifying the object captured by the second portable terminal, and the condition information representing the condition for displaying, in the first portable terminal, the content represented by the content information; and causing the server apparatus to store, in the database, the content information, the object specifying information and the condition information transmitted by the second portable apparatus by associating the content information, the object specifying information and the condition information with one another.

### 1. Embodiment

1-1. Configuration

1-1-1. Communication System

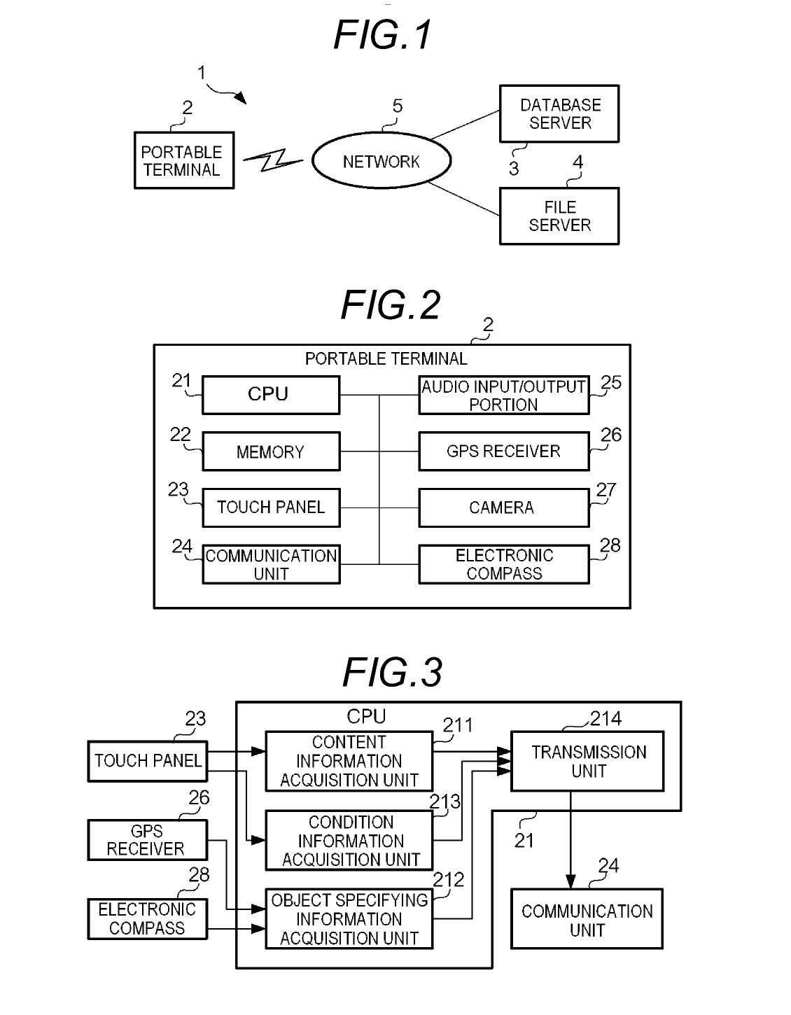

FIG. 1 is a schematic diagram illustrating a configuration of a communication system 1 according to an embodiment of the present invention. The communication system 1 is a system that offers a service for sharing, among users, additional information to be displayed using AR technology by being superimposed on an object in a reality space. As shown in FIG. 1, the communication system 1 includes a portable terminal 2, a database server 3, and a file server 4. The respective units are connected to one another through a network 5. The network 5 is a network configured by, e.g., a mobile communication network or the Internet. Incidentally, plural portable terminals 2 may be connected to the network 5.

1-1-2. Portable Terminal 2

The portable terminal 2 is an apparatus for displaying additional information by superimposing the additional information on an object in a reality space using AR technology, and for registering the additional information in the database server 3. The portable terminal 2 is, e.g., a mobile phone, a smartphone, a personal digital assistant (PDA), or a tablet terminal. FIG. 2 is a block diagram illustrating a hardware configuration of the portable terminal 2. As shown in FIG. 2, the portable terminal 2 includes a CPU 21, a memory 22, a touch panel 23, a communication unit 24, an audio input/output portion 25, a global positioning system (GPS) receiver 26, a camera 27, and an electronic compass 28.

The CPU 21 is a processor that controls each component of the portable terminal 2 by executing a program stored in the memory 22. The memory 22 is, e.g., a flash memory that stores a program to be executed by the CPU 21, and a sound file. The sound file is, e.g., a standard musical instrument digital interface (MIDI) file (incidentally, “MIDI” is a registered trademark). The sound file may be an audio data file such as a Moving Picture Experts Group (MPEG) audio-layer-3 (MP3) file. The touch panel 23 includes a liquid crystal display, and a touch panel to be arranged on the liquid crystal display. The touch panel 23 displays a display-screen-image and receives an input operation performed by a user. The communication unit 24 is an interface card for performing communication with an external apparatus via the network 5.

The audio input/output portion 25 includes a microphone, speakers, and an audio-processing circuit such as a digital signal processor (DSP). The audio input/output portion 25 outputs, to the CPU 21, audio signals that represent sounds picked up by the microphone. The audio input/output portion 25 also outputs, from the speakers, sounds represented by the audio signals input from the CPU 21. The GPS receiver 26 receives electric waves generated from a GPS satellite. The camera 27 is, e.g., a digital camera having image pickup elements, such as charge-coupled devices, and lenses. The camera 27 can capture not only a still image but a moving image. The electronic compass 28 includes a magnetic sensor and specifies a direction in which the lenses of the camera 27 are directed.

FIG. 3 is a block diagram illustrating a configuration of functions implemented by the CPU 21. Particularly, the functions relate to processing of uploading, to the database server 3, tag setting information to be described below. As illustrated in FIG. 3, the functions respectively corresponding to a content information acquisition unit 211, an object specifying acquisition unit 212, a condition information acquisition unit 213 and a transmission unit 214 are implemented by executing a program stored in the memory 22 by the CPU 21.

The content information acquisition unit 211 acquires content information representing a content to be displayed on an object in a reality space captured by the portable terminal 2. Specifically, the object in the reality space is captured by the camera 27 of the portable terminal 2. The capturing includes capturing of a still image, and capturing of a moving image. The capturing is sufficient if an object in a reality space is displayed in the touch panel 23. It is not necessary to store, in the memory 22, image data representing the object. According to the present embodiment, the object in the reality space is, e.g., an artificial object such as a building or an advertising display, and a natural object such as a mountain, a waterway, a lake, or a timber. The content is, e.g., a text, an image, a moving image, or a musical composition. According to the present embodiment, the content information may be either the content itself or information for identifying the content. The content information acquisition unit 211 acquires an identification (ID) selected by a user using the touch panel 23 from IDs of sound files stored in the memory 22.

The object specifying information acquisition unit 212 acquires object specifying information for specifying an object captured by the portable terminal 2. According to the present embodiment, the object specifying information is, e.g., position information (e.g., a latitude/longitude or identification information of a base station) representing a position of the portable terminal 2 which captures the object. Alternatively, the object specifying information is a combination of this position information and direction information representing a direction (or a capturing direction) of the object when viewed from the portable terminal 2. The object specifying information acquisition unit 212 acquires position information of the portable terminal 2, based on, e.g., an electric wave received by the GPS receiver 26. The object specifying information acquisition unit 212 acquires direction information representing a direction specified by the electronic compass 28. Incidentally, the object specifying information acquired by the object specifying information acquisition unit 212 may manually be input by a user using the touch panel 23.

The condition information acquisition unit 213 acquires condition information representing a condition for displaying, in the portable terminal 2, a content represented by the content information that is acquired by the content information acquisition unit 211. According to the present embodiment, the content information is information representing a time, a weather condition, and a user attribute. The time is a time and a date, a period of time (e.g., a time zone, or a season), and the like. The weather condition is a weather, a temperature, a humidity, an atmospheric pressure, a wind velocity, or the like. The user attribute is a gender, an age, a hobby, an identification (ID), or the like. That is, the condition information is information representing conditions (i.e., external conditions) associated with external factors of the portable terminal 2. Incidentally, this condition information does not include the above object specifying information. Specifically, the condition information does not include position information representing a position of an object, and direction information representing a direction of the object when viewed from the portable terminal 2. The condition information acquisition unit 213 acquires condition information representing a condition input by a user using, e.g., the touch panel 23. Alternatively, the condition information acquisition unit 213 acquires condition information preset in the memory 22.

The transmission unit 214 associates the content information acquired by the content information acquisition unit 211, the object specifying information acquired by the object specifying information acquisition unit 212, and the condition information acquired by the condition information acquisition unit 213 with one another and transmits such types of information associated with one another to the database server 3. Particularly, the transmission unit 214 transmits, as the tag setting information, the database server 3 using the communication unit 24.

1-1-3. Database Server 3

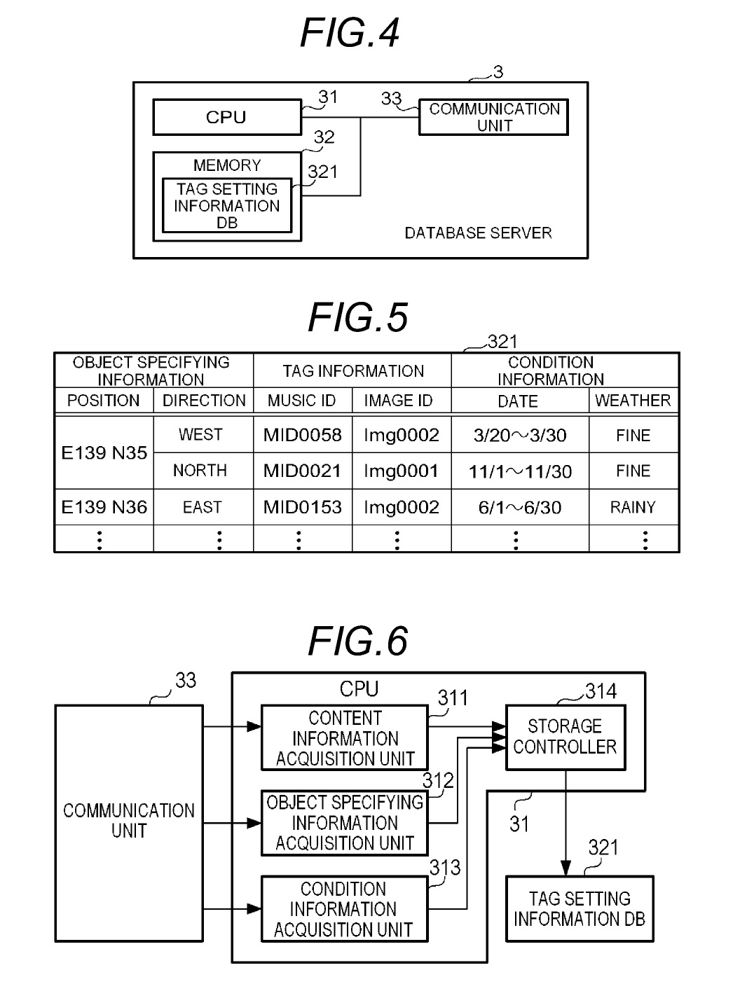

The database server 3 is a server apparatus for storing tag setting information uploaded by the portable terminal 2. FIG. 4 is a block diagram illustrating a hardware configuration of a database server 3. As shown in FIG. 4, the database server 3 includes a CPU 31, a memory 32, and a communication unit 33. The CPU 31 controls each component of the database server 3 by executing a program stored in the memory 32. The memory 32 is a storage unit such as a hard disk drive (HDD) and stores programs to be executed by the CPU 31. The memory 32 stores a tag setting information DB 321. The communication unit 33 is an interface card for performing communication with an external apparatus via the network 5.

FIG. 5 is a table illustrating an example of a data organization of the tag setting information DB 321. The tag setting information DB 321 is a database that stores object specifying information, tag information, and condition information by associating such types of information with one another. As shown in FIG. 5, each record configuring the tag setting information DB 321 includes fields “position”, “direction”, “music ID”, “image ID”, “date”, and “weather”. The field “position” represents the position (e.g., a latitude/longitude or identification information of a base station) of the portable terminal 2 that captures an object. The field “direction” represents the direction of an object when viewed from the portable terminal 2. The field “music ID” represents identification information of each sound file. The field “image ID” represents identification information of data of an icon representing each sound file. The information “image ID” may be automatically selected at the database server 3 according to a sound file type. Alternatively, the information “image ID” may be selected at the portable terminal 2. The field “date” represents a date on which each tag is displayed. The field “weather” represents a weather (e.g., fine, rainy, cloudy, and the like) by which each tag is displayed.

FIG. 6 is a block diagram illustrating a configuration of a function implemented by the CPU 31. Particularly, the function relates to processing of storing tag setting information uploaded by the portable terminal 2 in the tag setting information DB 321. A program stored in the memory 32 is executed by the CPU 31. Thus, as shown in FIG. 6, the function corresponding to each of a content information acquisition unit 311, an object specifying information acquisition unit 312, a condition information acquisition unit 313, and a storage controller 314 is implemented.

The content information acquisition unit 311 (which is an example of a “second content information acquisition unit”) acquires content information representing a content to be displayed by being superimposed on an object in a reality space captured by the portable terminal 2. The content information acquisition unit 311 acquires a sound file ID that is transmitted by the portable terminal 2 and received by the communication unit 33. The object specifying information acquisition unit 312 (which is an example of a “second object specifying acquisition unit”) acquires object specifying information for specifying an object captured by the portable terminal 2. The object specifying information acquisition unit 312 acquires, e.g., position information representing a position of the portable terminal 2, and direction information representing a direction of an object that is captured by the portable terminal 2 when viewed from the portable terminal 2. Each of the position information and the direction information is transmitted by the portable terminal 2 and received by the communication unit 33.

The condition information acquisition unit 313 (which is an example of a “second condition information acquisition unit”) acquires condition information representing a condition for displaying, in the portable terminal 2, a content represented by content information acquired by the content information acquisition unit 311. The content information acquisition unit 313 acquires, e.g., content information that is transmitted by the portable terminal 2 and received by the communication unit 33 and that represents a condition for displaying a date, on which a tag is displayed, and a weather in which the tag is displayed. Incidentally, the condition information acquisition unit 313 may acquire condition information preset in the memory 32. The storage controller 314 stores the content information acquired by the content information acquisition unit 311, the object specifying information acquired by the object specifying information acquisition unit 312, and the condition information acquired by the condition information acquisition unit 313 in the tag setting information DB 321 by associating the content information, the object specifying information and the condition information with one another.

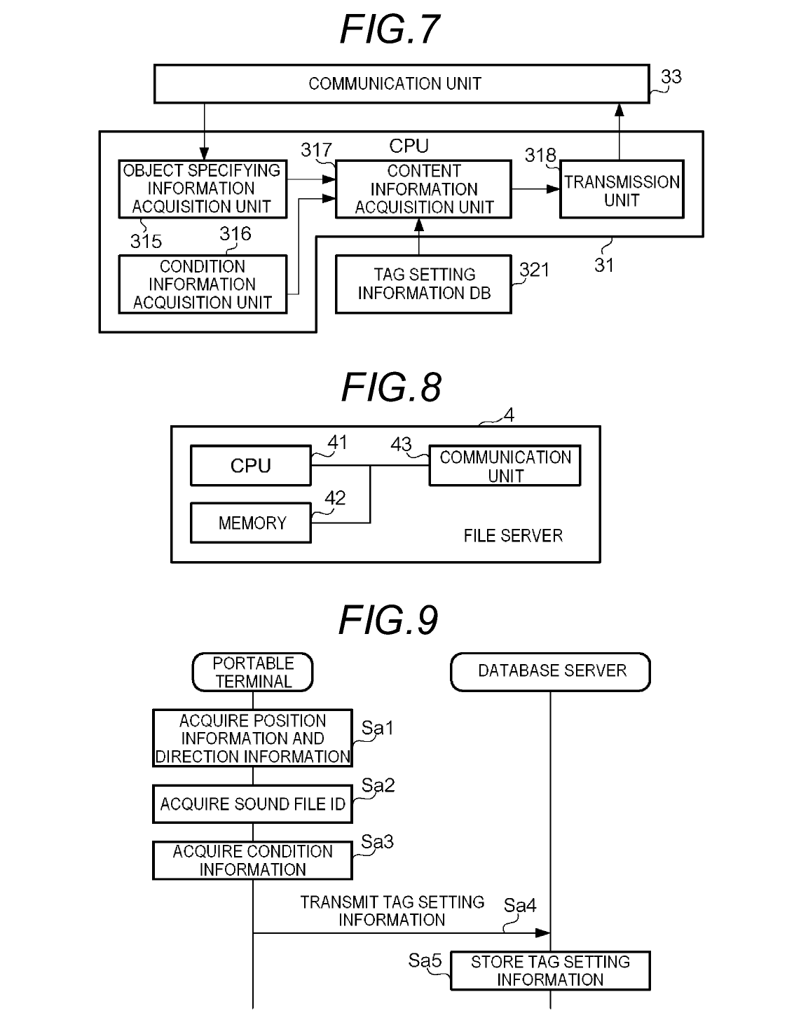

FIG. 7 is a block diagram illustrating a configuration of another function implemented by the CPU 31. Particularly, the function relates to processing of downloading tag information to the portable terminal 2. A program stored in the memory 32 is executed by the CPU 31. Thus, as shown in FIG. 7, the function corresponding to each of an object specifying information acquisition unit 315, a condition information acquisition unit 316, a content information acquisition unit 317 and a transmission unit 318 is implemented.

The object specifying information acquisition unit 315 (which is an example of a “first object specifying information acquisition unit”) acquires object specifying information for specifying an object in a reality space by the portable terminal 2. The object specifying information acquisition unit 315 acquires, e.g., position information representing a position of the portable terminal 2, and direction information representing a direction of an object captured by the portable terminal 2 when viewed from the portable terminal 2. Each of the position information and the direction information is transmitted by the portable terminal 2 and received by the communication unit 33. The condition information acquisition unit 316 (which is an example of a “first condition information acquisition unit”) acquires condition information representing a condition relating to a situation into which the portable terminal 2 is put, or to a user of the portable terminal 2. The condition information acquisition unit 316 acquires date information representing a current date, and weather information representing a current weather.

The content information acquisition unit 317 (which is an example of a “first content information acquisition unit”) acquires content information associated with each of object specifying information acquired by the object specifying information acquisition unit 315 by referring to the tag setting information DB 321, and condition information acquired by the condition information acquisition unit 316. For example, the content information acquisition unit 317 acquires the tag information associated with the position information, the direction information and the condition information by referring to the tag setting information DB 321. The transmission unit 318 transmits, to the portable terminal 2, the content information acquired by the content information acquisition unit 317. The transmission unit 318 transmits tag information to the portable terminal 2, using the communication unit 33.

1-1-4. File Server 4

The file server 4 is a server apparatus that supplies a sound file to the portable terminal 2. FIG. 8 is a block diagram illustrating a hardware configuration of the file server 4. As shown in FIG. 8, the file server 4 includes a CPU 41, a memory 42, and a communication unit 43. The CPU 41 controls each component of the file server 4 by executing a program stored in the memory 42. The memory 42 is a memory unit such as a HDD, and stores a program to be executed by the CPU 41, and a sound file. The communication unit 43 is an interface card for making communication with an external apparatus via the network 5.

In addition to supplying a sound file, the file server 4 supplies an application-program for generating the sound file. This application-program may be utilized by being downloaded to the portable terminal 2. Alternatively, the application-program may be utilized in the portable terminal 2 as a web application-program. The program for generating a sound file is, e.g., a program of what is called a music sequencer type, a program of an automatic generation type, a program for sampling sounds output from a microphone, a musical instrument, and a device, which are attached or connected to the portable terminal 2, and a program of the type that treats three elements of music (i.e., a rhythm, a melody, and a harmony) as parts. Such programs may be utilized by the portable terminal 2 by being stored in an application-program server other than the file server 4.

1-2. Operation

An operation of the communication system 1 is described hereinafter. More specifically, processing of uploading tag setting information to the database server 3 by the portable terminal 2, processing of downloading tag information from the database server 3 by the portable terminal 2, and processing of reproducing a sound file by the portable terminal 2 are described hereinafter.

1-2-1. Tag Setting Information Uploading Processing

FIG. 9 is a sequence chart illustrating processing of uploading tag setting information to the database server 3 by the portable terminal 2. Processing illustrated in FIG. 9 is performed by starting a predetermined application-program stored in the memory 22 by the CPU 21 of the portable terminal 2. In this processing, first, in step Sa1, the object specifying information acquisition unit 212 of the portable terminal 2 acquires position information of the portable terminal 2, based on an electric wave received by the GPS receiver 26. In addition, the object specifying information acquisition unit 212 acquires direction information representing a direction specified by the electronic compass 28. Incidentally, such types of information may manually be input by a user using the touch panel 23.

Next, in step Sa2, the content information acquisition unit 211 of the portable terminal 2 acquires a sound file. Specifically, the content information acquisition unit 211 causes the touch panel 23 to indicate IDs of sound files stored in the memory 22. Then, the content information acquisition unit 211 acquires an ID of a sound file selected by a user from the indicated IDs. Then, in step Sa3, the condition information acquisition unit 213 of the portable terminal 2 acquires condition information. Particularly, the condition information acquisition unit 213 causes the touch panel 23 to indicate options for a date, and options for a weather, and acquires condition information representing the selected date and the selected weather.

Next, in step Sa4, the transmission unit 214 of the portable terminal 2 transmits the position information, the direction information, the ID of a sound file, and the condition information acquired in the above steps Sa1 to Sa3 to the database server 3 as tag setting information. Then, in step Sa5, the storage controller 314 receiving the tag setting information stores this information in the tag setting information DB 321. Incidentally, in step Sa4, the transmission unit 214 of the portable terminal 2 may acquire music information, such as a name of a music identified from the ID of a sound file and a name of an artist, from an external server apparatus, and transmit the acquired music information to the database server 3 in addition to the tag setting information. The storage controller 314 of the database server 3 may store the music information in the tag setting information DB 321 as the tag setting information.

1-2-2. Tag Information Downloading Processing

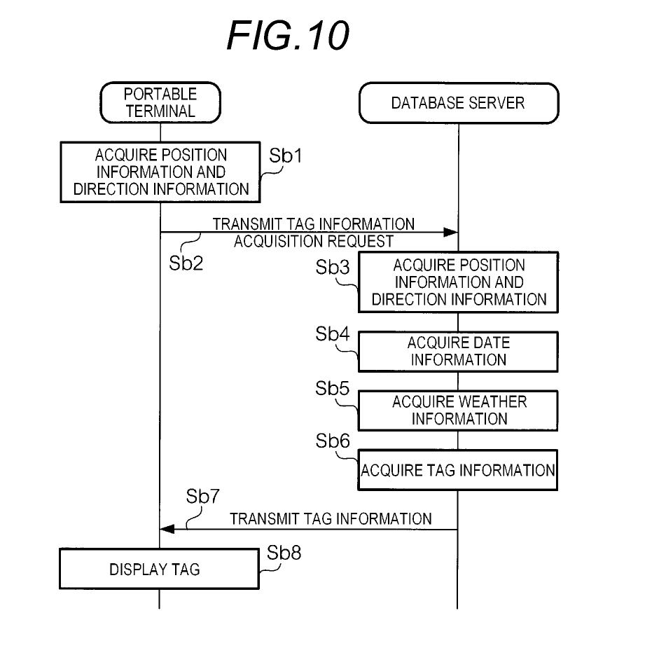

FIG. 10 is a sequence chart illustrating processing of downloading tag information from the database server 3 by the portable terminal 2. Processing illustrated in FIG. 10 is performed by starting a predetermined application-program stored in the memory 22 by the CPU 21. In this processing, first, in step Sb1, the object specifying information acquisition unit 212 of the portable terminal 2 acquires position information of the portable terminal 2, based on an electric wave received by the GPS receiver 26. Then, the object specifying information acquisition unit 212 also direction information representing a direction specified by the electronic compass 28. Next, in step Sb2, the CPU 21 of the portable terminal 2 transmits an acquisition-request for acquiring tag information, to which the position information and the direction information acquired in step Sb1 are added, using the communication unit 24.

In step Sb3, the object specifying information acquisition unit 315 of the database server 3, which receives the acquisition-request, acquires the position information and the direction information added to the acquisition-request. Next, in step Sb4, the condition information acquisition unit 316 of the database server 3 acquires date information representing a current date. The condition information acquisition unit 316 acquires, e.g., date information output from a timer unit (not shown) included by the database server 3. Next, in step Sb5, the condition information acquisition unit 316 acquires weather information representing a current weather. The condition information acquisition unit 316 acquires the weather information from, e.g., an external server apparatus that supplies weather information.

Next, in step Sb6, the content information acquisition unit 317 of the database server 3 acquires tag information associated with the position information, the direction information, the date information and the weather information acquired in steps Sb3 to Sb5, by referring to the tag setting information DB 321. Particularly, the content information acquisition unit 317 acquires a sound file ID and an image ID. For example, in case where the acquired position information represents “E139N35”, where the acquired direction information represents “west”, where the date represents “March 25”, and where the weather information represents “fine”, the content information acquisition unit 317 acquires a sound file ID “MID0058” and an image ID “1 mg0002” from the tag setting information DB 321. Next, in step Sb7, a transmission unit 318 of the database server 3 transmits, to the portable terminal 2, the tag information acquired in step Sb6, using the communication unit 33.

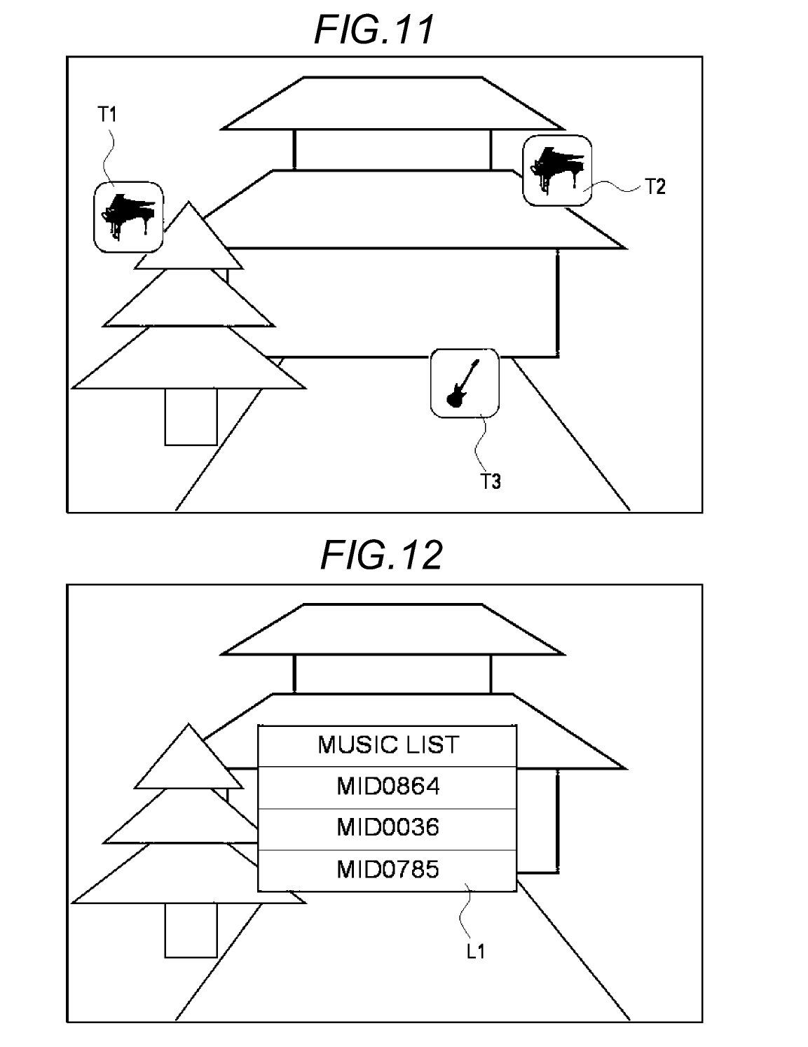

The CPU 21 of the portable terminal 2 receiving this tag information causes the touch panel 23 to display each tag, based on the received tag information. FIG. 11 is an image view illustrating an example of a display-screen-image in which the tags are indicated. In FIG. 11, reference-characters T1 to T3 designate tags. A tag T1 illustrated in FIG. 11 is an example of a tag in the case of employing a timber indicated on the left side of the display-screen-image as an object. Each of tags T2 and T3 is an example of employing a building displayed at the center of the display-screen-image as an object. Incidentally, the CPU 21 of the portable terminal 2 receiving the tag information may cause the touch panel 23 to indicate a list of sound file IDs, instead of indicating tags. FIG. 12 is an image view illustrating an example of a display-screen-image displayed in the touch panel 23 in this case. Reference character L1 in FIG. 12 designates a list of sound file IDs. The CPU 21 of the portable terminal 2 receiving the tag information may indicate a link to a site, at which a sound file is sold, at a tag.

1-2-3. Sound File Reproducing Processing

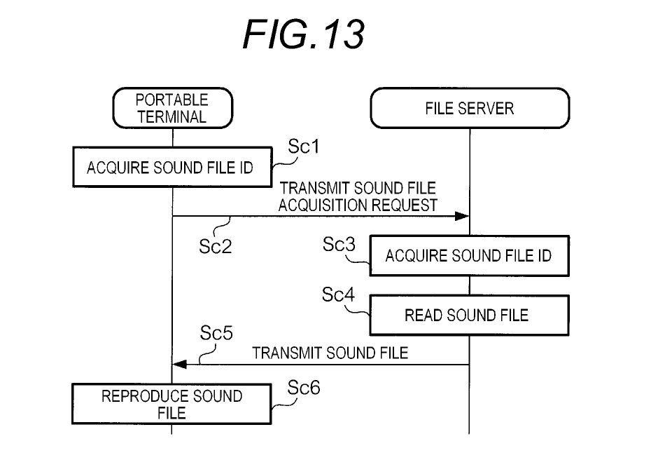

FIG. 13 is a sequence chart illustrating processing of reproducing a sound file by the portable terminal 2. Processing illustrated in FIG. 13 is performed if a user selects a tag indicated in the display-screen-image in a state in which the display-screen-image illustrated in FIG. 11 is displayed in the portable terminal 2. In this processing, first, in step Sc1, the content information acquisition unit 211 of the portable terminal 2 acquires a sound file ID corresponding to the tag selected by the user. Now, if the display-screen-image illustrated in FIG. 12 instead of the display-screen-image illustrated in FIG. 11 is displayed, the sound file ID selected by the user is acquired. Next, in step Sc2, the transmission unit 214 transmits, to the file server 4, an acquisition-request for acquiring a sound file to which a sound file ID acquired in step Sc1 is assigned, using the communication unit 24.

In step Sc3, the CPU 41 of the file server 4 receiving this acquisition-request acquires a sound file ID assigned to this acquisition request. Next, in step Sc4, the CPU 41 reads, from the memory 42, a sound file identified by the sound file ID acquired in step Sc3. Then, in step Sc5, the CPU 41 transmits the sound file read in step Sc4 to the portable terminal 2 using the communication unit 43. In step Sc6, the CPU 21 of the portable terminal 2, which receives this sound file, causes the audio input/output portion 25 to reproduces this sound file.

Incidentally, in this processing, a method of reproducing a sound file is not limited to what is called a download-reproducing method and may be a streaming reproduction method. In a case where a sound file identified by the sound file ID specified in step Sc1 in this processing is stored in the memory 22, the CPU 21 of the portable terminal 2 may reproduce a sound file stored in the memory 22 without acquiring a sound file from the file server 4. Alternatively, the CPU 21 may be adapted to check once whether the sound file is stored in the memory 22, and to acquire the sound file from the file server 4 only if the sound file is not stored in the memory 22. At that time, the CPU 21 may be adapted to request approval from a user, to acquire, if approval is obtained from the user, a sound file from the file server 4, and to finish this processing if approval is not obtained from the user.

In the above processing, if the sound file requested by the portable terminal 2 is not stored in the memory 42 of the file server 4, the file server 4 may transmit, to the portable terminal 2, a notice that the sound file is not present. Then, the CPU 21 of the portable terminal 2 may cause the touch panel 23 to indicate the notice.

Incidentally, the portable terminal 2 used in the “1-2-1 Tag Setting Information Uploading Processing” may either differ from or be the same as the portable terminal 2 used in the “1-2-2 Tag Information Downloading Processing” and the “1-2-3 Sound File Reproducing Processing”.

### 2. Modifications

The above embodiment may be modified as follows. In addition, the following modifications may be combined with one another.

In the above embodiment, the sound file ID is registered in the database server 3 as tag setting information. However, ID information of a text, an image, or a moving image may be registered as tag setting information.

In the above embodiment, both of the position information of the portable terminal 2 and the direction information representing a direction of an object captured by the portable terminal 2 when viewed from the portable terminal 2, are registered in the database server 3 as object specifying information. However, the embodiment may be modified such that only the position information is registered as object specifying information. Alternatively, the embodiment may be modified such that information representing a capturing magnification is further registered as object specifying information. In this case, the object specifying information acquisition unit 315 of the database server 3 acquires information representing a capturing magnification ratio of the portable terminal 2 requesting the downloading of tag information. In addition, the object specifying information acquisition unit 315 acquires, with reference to the tag setting information DB 321, tag information associated with the information representing a capturing magnification ratio.

In the above embodiment, the condition information is transmitted from the portable terminal 2 to the database server 3 and registered as condition information. However, condition information may automatically be set by the database server 3. For example, position information, date-information representing a date and weather-information representing a weather at the time of receiving position information and a sound file ID from the portable terminal 2 may automatically be registered by the database server 3 as condition information.

In the above embodiment, the date information and the weather information are registered as condition information. However, the embodiment may be modified such that only one of the date information and the weather information is registered. In addition, information representing a period of time or a season may be registered instead of the date information. Alternatively, the embodiment may be modified such that information representing a weather condition, such as a temperature, a humidity, an atmospheric pressure, or a wind velocity may be registered, instead of the weather information.

Alternatively, the embodiment may be modified such that user attribute information is registered instead of or in addition to the date information and the weather information. The user attribute information can be an external factor of the portable terminal. Thus, the user attribute information is included in external conditions. For example, a gender, an age, a hobby, an ID, and the like of a user that the former user wishes to employ as a reader of the tag may be registered as condition information. In this case, the condition information acquisition unit 316 of the database server 3 acquires the attribute information of a user of the portable terminal 2, who makes a request for downloading tag information. Then, the condition information acquisition unit 316 acquires tag information associated with the attribute information by referring to the tag setting information DB 321.

Alternatively, attribute information of a user registering tag setting information may be registered as user attribute information. Then, when the database server 3 downloads tag information to the portable terminal 2, this user attribute information may be supplied to the portable terminal 2 together with the tag information. In this case, a user of the portable terminal 2 receiving the tag information can perform filtering on the tag to be displayed on the screen, based on the user attribute information received together with the tag information.

In the above embodiment, information representing an amount of characteristic obtained by analyzing an image captured by the portable terminal 2 may be registered together with the tag information in the database server 3, instead of object specifying information and condition information. For example, the following functions may be implemented by the CPU 31 of the database server 3.

(1) A function corresponding to an amount-of-characteristic specifying unit that specifies an amount of characteristic obtained by analyzing an image captured by the first portable terminal.
(2) A function corresponding to a content information acquisition unit that acquires content information associated with amount-of-characteristic information representing an amount of characteristic having a degree of similarity to the amount of characteristic specified by the above amount-of-characteristic specifying unit, which degree is equal to or more than a predetermined threshold, by referring to a database in which content information representing a content to be displayed by being superimposed on an object in a reality space indicated in an image captured by the second portable terminal, and information representing an amount of characteristic obtained by analyzing the image captured by the second portable terminal are stored by associating the content information and the amount-of-characteristic information with each other.
(3) A function corresponding to a transmission unit that transmits, to the first portable terminal, content information obtained by the content information acquisition unit.

Incidentally, a known technology may be used as a technology of analyzing an image and calculating an amount of characteristic. According to this modification, a user who registers tag setting information can display a tag that the user wishes to display in the portable terminal 2 put into a similar situation even at a position which is not always the same position, and can reproduce a sound file.

In the above embodiment and modifications, programs executed by the CPU 21 of the portable terminal 2 or the CPU 31 of the database server 3 may be supplied via a computer readable recording medium. The recording medium is, e.g., a magnetic recording medium such as a magnetic tape or a magnetic disc, an optical recording medium such as an optical disc, a magneto-optical recording medium, and a semiconductor memory. Alternatively, the program may be supplied via a network such as the Internet.

What is claimed is:

1: A server apparatus, comprising:
a first object specifying information acquisition unit configured to acquire object specifying information for specifying an object in a reality space captured by a first portable terminal;
a first condition information acquisition unit configured to acquire condition information including an external condition of the first portable terminal;
a first content information acquisition unit configured to acquire content information associated with the object specifying information acquired by the first object specifying information acquisition unit and the condition information acquired by the first condition information acquisition unit by referring to a database, wherein the database stores content information representing a content displayed by being superimposed on an object in a reality space captured by a second portable terminal, object information for identifying the object captured by the second portable terminal, and condition information representing a condition for displaying, in the first portable terminal, the content represented by the content information by associating the content information, the object information, and the condition information with one another; and
a transmission unit configured to transmit, to the first portable terminal, the content information acquired by the first content information acquisition unit.

2: The server apparatus according to claim 1, wherein
the external condition of the first portable terminal includes a situation into which the first portable terminal is put.

3: The server apparatus according to claim 1, wherein
the external condition of the first portable terminal includes attribute information on a user of the first portable terminal.

4: The server apparatus according to claim 1, wherein
the first portable terminal is same as the second portable terminal.

5: The server apparatus according to claim 1, wherein
the first portable terminal differs from the second portable terminal.

6: The server apparatus according to claim 1, wherein
the content information includes identification information representing a sound file.

7: The server apparatus according to claim 1, further comprising:
a second content information acquisition unit configured to acquire content information representing a content to be displayed by being superimposed on an object in a reality space captured by the second portable terminal;
a second object specifying information acquisition unit configured to acquire object specifying information for specifying the object captured by the second portable terminal;
a second condition information acquisition unit configured to acquire condition information representing a condition for displaying, in the first portable terminal, the content represented by the content information; and
a storage controller configured to store the content information acquired by the second content information acquisition unit, the object specifying information acquired by the second object specifying information acquisition unit and the condition information acquired by the second condition information acquisition unit into the database by associating the content information, the object specifying information, and the condition information with one another.

8: A server apparatus, comprising:
a content information acquisition unit configured to acquire content information representing a content to be displayed by being superimposed on an object in a reality space captured by a portable terminal;
an object specifying information configured to acquire object specifying information for specifying the object captured by the portable terminal;
a condition information acquisition unit configured to acquire condition information that represents a condition for displaying a content represented by the content information in the portable terminal or another portable terminal and that includes an external condition of the portable terminal; and
a storage controller configured to store the content information, the object specifying information and the condition information into a database by associating the content information, the object specifying information and the condition information with one another.

9: The server apparatus according to claim 8, wherein
the external condition of the portable terminal includes a situation in which the portable terminal is put.

10: The server apparatus according to claim 8, wherein
the external condition of the portable terminal includes attribute information on a user of the portable terminal.

11: The server apparatus according to claim 8, wherein
the content information includes identification information representing a sound file.

12: A communication method performed in a communication system including a plurality of portable terminals and a server apparatus, the communication method comprising:
causing a first portable terminal to transmit, to the server apparatus, object specifying information for specifying an object in a reality space captured by the first portable terminal;
causing the server apparatus to receive the object specifying information transmitted to the server apparatus;
causing the server apparatus to acquire condition information representing an external condition of the first portable terminal; and
causing the server apparatus to acquire content information associated with the received object specifying information and the acquired condition information by referring to a database, wherein the database stores content information representing a content to be displayed by being superimposed on an object in a reality space captured by a second portable terminal, object information for identifying the object captured by the second portable terminal, and condition information representing a condition for displaying, in the first portable terminal, a content represented by the content information, by associating the content information, the object information, and the condition information with one another.

13: The communication method according to claim 12, wherein
the first portable terminal transmits the condition information to the server apparatus, together with the object specifying information, and
the server apparatus acquires the condition information from the first portable terminal.

14: The communication method according to claim 12, further comprising:
causing the second portable terminal to transmit, to the server apparatus, the content information representing a content to be displayed by being superimposed on the object captured by the second portable terminal, the object specifying information for specifying the object captured by the second portable terminal, and the condition information representing the condition for displaying, in the first portable terminal, the content represented by the content information; and
causing the server apparatus to store, in the database, the content information, the object specifying information and the condition information transmitted by the second portable apparatus by associating the content information, the object specifying information and the condition information with one another.
